(19) United States
(12) Patent Application Publication
(10) Pub. No.: US 2026/0010128 A1
(43) Pub. Date: Jan. 8, 2026

(54) DUAL DIGITAL TWIN SYSTEMS FOR CONTROL SYSTEMS AND METHODS OF USE

(71) Applicant: Purdue Research Foundation, West Lafayette, IN (US)

(72) Inventors: Dominique Winston Sealy, West Lafayette, IN (US); Khalifa Ahmed Alremeithi, West Lafayette, IN (US)

(21) Appl. No.: 19/258,438

(22) Filed: Jul. 2, 2025

Related U.S. Application Data
(60) Provisional application No. 63/667,030, filed on Jul. 2, 2024.

(51) Int. Cl. G05B 13/04

(52) U.S. Cl. CPC G05B 13/042

(57) ABSTRACT

Dual digital twin systems and computerized control devices, methods, and software associated therewith. Such a dual digital twin system may be used for analyzing and/or controlling an associated physical device. The system includes a primary digital twin hosted on a computer processing unit for robust data handling and system reliability, and a secondary digital twin embedded within a computerized control device configured for direct control over operations of the associated physical device. Control of the physical device can be automatically switched between the primary and secondary digital twins in the event that one or the other of the digital twins ceases to function properly or data network interruptions occur. The dual digital twin system may be used to dynamically update control programs on the computerized control device without halting the functioning of the associated physical device or manually reprogramming the computerized control device.

### CROSS-REFERENCE TO RELATED APPLICATIONS

This application claims the benefit of provisional U.S. Patent Application No. 63/667,030 filed Jul. 2, 2024, the contents of which are incorporated herein by reference.

### STATEMENT REGARDING PRIOR DISCLOSURES BY AN INVENTOR OR JOINT INVENTOR

The following disclosures are related to the disclosures made herein and was made by one or more inventor or joint inventor of the present invention:
K. Alremeithi, P. Giri, and W. Sealy, “Collaborative Intelligent Industrial Robots (CIIR) Framework,” 2023 International Conference on Electrical, Communication and Computer Engineering (ICECCE), Dubai, United Arab Emirates, December 2023, pp. I-6, doi: 10.1109/ICECCE61019.2023.10442250.
T. C. Washington and W. Sealy, “Programming by Demonstration using Mixed Reality and Simulated Kinematics,” 2024 IEEE World AI IoT Congress (AIIoT), Seattle, WA, USA, May 2024, pp. 387-392, doi: 10.1109/AIIoT61789.2024.10579016.

### BACKGROUND OF THE INVENTION

The invention generally relates to computerized monitoring and/or control systems, including but not limited to industrial control systems for automation systems utilized in industrial environments. More particularly, the invention relates to computer-implemented digital twin systems for monitoring, analyzing, and/or controlling physical devices, as nonlimiting examples, industrial machinery and industrial robots, and further relates to computerized control devices (e.g., programmable logic controllers (PLCs)), methods, and software associated therewith.

Digital twin technology in industrial control systems involves creating a virtual replica (referred to as a “digital twin”) of physical devices, to enable real-time monitoring, analysis, and optimization of those devices, as well as processes they perform and/or systems that comprise them. Such physical devices and their uses of digital twin technology include, but are not limited to, industrial equipment and process controls, manufacturing equipment and process controls, medical equipment, automotive equipment and controls, aeronautical equipment and controls, environmental control systems, agricultural equipment and controls, and so on. By utilizing data from sensors, internet-of-things (IoT) devices, and other sources, digital twins provide a comprehensive, dynamic view of the operational state of the physical devices.

For example, in a typical scenario, conventional digital twin technology is used for the monitoring, control, and/or management of one or more pieces of industrial machinery. A virtual model (the digital twin) of each of the machines is created and hosted on a remote computer. Each machine is equipped with one or more various sensors that collect various operational data on various real-world operating parameters, such as operational speeds, temperatures, vibration levels, pressures, etc. Computerized control devices, typically one or more programmable logic controllers (PLCs), are associated with each machine to control the actual operation of the machine and/or of the sensors associated with the machine. The data collected by the sensors is transmitted in real-time to the digital twin of the machine, which replicates the physical conditions and performance metrics of the actual equipment within the corresponding virtual environment of the digital twin. Then, by analyzing the digital twin, various use scenarios can be analyzed and/or predicted without disrupting or having to physically inspect the actual machines. For example, the digital twin combined with the operational data can be used to predict potential failures, optimize performance, and adjust maintenance schedules to prevent unexpected downtimes. The digital twin can also simulate different operational conditions to test and/or enhance the machine's efficiency, reliability, or other parameters to help achieve optimal performance and reduced operational costs. Of course, digital twin systems can be used for analyzing and/or predicting various operational parameters for an almost infinite number of real-world applications.

Conventional digital twin systems typically have a single digital twin associated with a given PLC. These single digital twin systems often lack robust failover capabilities, seamless integration with existing infrastructure, and/or the ability to handle diverse operational demands without extensive reconfiguration. In addition, conventional digital twin systems typically only provide theoretical modeling capabilities. Thus, with conventional digital twin systems, the PLCs associated with a given piece of equipment or process often require manual intervention for making updates and are unable to dynamically predict failures or adapt to changing conditions in the associated physical equipment. Furthermore, although conventional single digital twin models may offer some predictive capabilities, they typically do not provide any operational control at the PLC level or ensure the system's operation during network disruptions or server issues.

In the field of industrial control systems, attempts have been made to address the challenges of enhancing system flexibility, resilience, and integration through different strategies. Some approaches focus on conventional digital twin technologies offering systems that simulate, predict, and optimize real-time product performance to improve automation processes. Other approaches focus on advanced PLC systems that provide robust PLCs designed to integrate smoothly into existing systems and handle complex tasks, thereby boosting system resilience. Other approaches focus on IoT and integration platforms that manage data flow and system monitoring across different production components, enhancing adaptability and efficiency. Yet other software and AI-driven approaches incorporate artificial intelligence (AI) to predict system failures and automatically adjust operations, thus increasing the adaptability and proactive responsiveness of systems. Moreover, other initiatives offer flexible and cost-effective systems for control software programming and integration, complementing commercial products. These technologies create a competitive landscape, each striving to offer more integrated, reliable, and flexible solutions, positioning their products as essential for modern industrial operations.

Nevertheless, it would be desirable to have a control system that can seamlessly integrate with both new and existing technologies and/or enhance system resilience through effective redundancy features.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, dual digital twin systems, as well as computer-implemented methods, software products, and computerized control devices associated therewith.

According to a nonlimiting aspect, a dual digital twin system for analyzing and/or controlling an associated physical device includes a primary digital twin hosted on a computer processing unit, such as a centralized or remote computer server, for robust data handling and system reliability, and a secondary digital twin embedded within a computerized control device configured for direct control over operations of the associated physical device.

According to another nonlimiting aspect, a computer-implemented method of using the dual digital twin system described above includes dynamically adjusting operations of the computerized control device in real time based on sensor data and/or production requirements to meet varying production demands and/or material specifications.

According to yet another nonlimiting aspect, a computer-implemented method of using the dual digital twin system described above includes automatically switching control of the associated physical device from the primary digital twin to the secondary digital twin when the primary digital twin malfunctions, and automatically switching control of the associated physical device from the second digital twin to the primary digital twin when the secondary digital twin malfunctions. In this way, the seamless failover between the primary digital twin and the secondary digital twin can be realized.

According to still another nonlimiting aspect, a software product has one or more non-transitory computer-readable media comprising instructions which, when executed by one or more processors, cause the one or more processors to implement any one of the computer-implemented methods described above.

In a still further nonlimiting aspect, a programmable logic controller (PLC) for controlling an associated physical device includes a multiplexer that receives input signals from one or mor. input modules and delivers output signals to one or more output modules, a computer processor in data communication with the multiplexer, and a power supply module operatively coupled to provide power to each of the computer processors, the input modules, and the output modules. The computer processor may be embedded with programming that, when executed, generates a secondary digital twin of the associated physical device. The computer processor may be embedded with programming that, when executed, communicates virtual input and/or output with a primary digital twin of the associated physical device on a second processor.

Technical aspects of dual digital twin systems, methods, software, and PLCs as described above preferably include the ability to provide a robust solution that is preferably capable of enhancing efficiency, flexibility, and/or sustainability of physical devices in industrial environments.

These and other aspects, arrangements, features, and/or technical effects will become apparent upon detailed inspection of the figures and the following description.

### BRIEF DESCRIPTION OF THE DRAWINGS

FIG. 1 is a schematic diagram of a nonlimiting example of a control system for a physical system incorporating a dual digital twin system of the present invention.

FIG. 2 is a schematic diagram of a dual digital twin system according to some nonlimiting aspects of the invention illustrating the data path during normal run time.

FIG. 3 is a schematic diagram of the dual digital twin system illustrating the data path during a network failure event.

FIG. 4 is a schematic diagram of the dual digital twin system illustrating the data path during dynamic control software (e.g., PLC) program changing.

FIG. 5 is a schematic diagram of a PLC form factor for hosting a secondary digital twin of the dual digital twin system according to a nonlimiting embodiment of the invention.

FIG. 6 is a functional block diagram of a 24V input module to a multiplexer of the PLC of FIG. 5.

FIG. 7 is an electrical schematic of the 24V input module of FIG. 5.

FIG. 8 is a functional block diagram of a 24V output module from the multiplexer of the PLC of FIG. 5.

FIG. 9 is an electrical schematic of the 24V output module of FIG. 8.

FIG. 10 is a functional block diagram of the multiplexer of FIG. 5.

FIG. 11 is an electrical schematic of the multiplexer of FIG. 10.

FIG. 12 is a functional block diagram of the power supply module to the Linux computer and outputs of the PLC of FIG. 5.

FIG. 13 is an electrical schematic of the power supply module of FIG. 12.

### DETAILED DESCRIPTION OF THE INVENTION

The intended purpose of the following detailed description of the invention and the phraseology and terminology employed therein is to describe what is shown in the drawings, which relate to one or more nonlimiting embodiments of the invention, and to describe certain but not all aspects of the embodiment(s) to which the drawings relate. The following detailed description also identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

The drawings represent embodiments and various aspects of a dual digital twin system 20 of the present invention. The dual digital twin system 20 can be implemented by integrating advanced digital twin technology with physical devices, including but not limited to industrial machinery and industrial robots of types deployed in factories and other industrial environments, as well as traditional programmable logic controllers (PLCs) utilized by physical devices. The system 20 has a dual digital twin setup, with a primary digital twin 22 hosted on a centralized server for robust data handling and system reliability, and a secondary digital twin 24 embedded within the PLC of a physical device for direct control over operations of the device. The system 20 is preferably readily adapted to be fully compatible with existing industrial technologies, ensuring seamless integration without disrupting ongoing operations. Some advantages of the system 20 preferably include the ability to perform mass customization of an industrial control system by dynamically adjusting operations on physical devices and their PLC(s) to meet varying production demands and/or material specifications. Additionally, the system 20 preferably enhances environmental sustainability by optimizing resource use and reducing waste. The system 20 also is preferably capable of improving operational flexibility through a Docker-based environment that allows multiple control software programs to be executed on demand. The dual digital twin system 20 is also preferably capable of providing a scalable, resilient, and efficient control mechanism that aligns with the principles of mass customization.

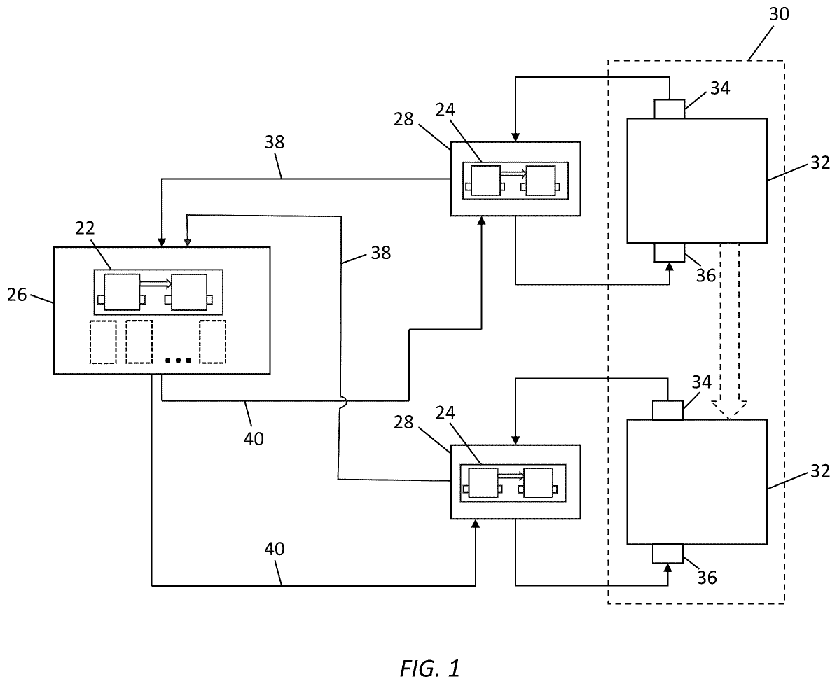

Turning now to the nonlimiting embodiments represented in the drawings, FIGS. 1 to 4 depict an embodiment of the dual digital twin system (also, simply, the “system”) 20 configured to enhance the management and/or control of various physical devices within various physical environments (hereinafter, physical systems), including but not limited to industrial environments, as nonlimiting examples, manufacturing, energy and resource management, and logistics and warehouse environments. While the following description will focus on particular examples directed to use with physical systems such as one or more pieces of industrial machinery, for example, industrial machinery and/or industrial robots in manufacturing environments, it is understood that the dual digital twin system 20 may be readily configured for use with essentially any type of physical devices and systems that can benefit from digital management and/or control using digital twin concepts in accordance with the principles of the present invention, some nonlimiting examples of which are described further on herein.

As noted above, the dual digital twin system 20 utilizes a dual digital twin architecture in which the primary digital twin 22 is adapted to model a physical system 30 to be monitored and/or controlled, and at least one secondary digital twin 24 that directly interfaces with a physical device 32 of or within the physical system 30. Each of the digital twins 22 and 24 includes its own virtual model of the physical system 30 and may further include additional analysis and/or control functionalities related to analyzing and/or controlling aspects of the physical system 30 in any manner now or later understood in the art relative to the use of digital twin technology. In the nonlimiting example shown in FIG. 1, the physical system 30 may include more than one physical device 32 desired to be monitored and/or controlled, such as a piece of machinery, an industrial robot, environmental data, etc. Typically, the physical system 30 will include one or more sensors 34 that collect and provide various types of operational data related to operation of the physical system 30 and/or one or more control devices 36 (e.g., actuators, switches, etc.) that provide control input to control the functioning of one or more of the physical devices 32. In some cases, the physical system 30 may include multiple physical devices 32 optionally working in concert with each other, for example in a manufacturing line, energy production facility, or environmental control system, etc.

The primary digital twin 22 is a first virtual model of the physical system 30 hosted on a computer processing system 26, such as a centralized computer server or network of computers, and functions as a strategic planner. Typically, although not necessarily, the computer processing system 26 is located remote from the physical system 30. The primary digital twin 22 may be configured in almost any manner as desired for monitoring, analyzing, designing, controlling, etc. aspects of the physical system 30. The primary digital twin 22 may, for example, be configured to perform data analyses, simulations, and optimizations to predict future conditions and formulate control strategies for the physical system 30. In addition, the primary digital twin 22 may be configured to provide control instructions for the various physical devices 32, for example, through one or more input/outputs of physical computerized control devices (hereinafter simply referred to as “controllers”) 28 that are associated with the physical devices 32 and connect with the one or more control devices 36 (e.g., actuators, switches, etc.) that are also associated with the physical devices 32 to provide control inputs to control functions of the one or more physical devices 32.

The secondary digital twin 24 is a second virtual model of the physical system 30 that is directly embedded/implemented on a controller 28 adapted to run physical devices 32 of the physical system 30. Depending on the application, such a controller 28 may comprise one or more PLCs adapted to control a particular physical device 32. Various sensors, actuators, and/or other types of interfaces embedded in or near equipment of the physical system 30 are operatively connected with each of the primary digital twin 22 and the secondary digital twin 24 in parallel to allow data communication of sensed information and control signals to and from each virtual model associated with the primary and secondary digital twins 22 and 24 and the equipment of the physical system 30. In the embodiment represented in FIG. 1, controllers 28 are specifically configured for individually controlling individual physical devices 32 of the physical system 30. The controllers 28 interface directly with the physical devices 32 of the physical system 30 to receive operational data from the physical system 30 and/or control the operation of the physical system 30 and its devices 32. For example, a controller 28 may receive operational data about various physical devices 32 from the various types of sensors 34 associated with the physical devices 32 and/or the controller 28 may send control signals for controlling operation of the various physical devices 32 within the physical system 30. In some embodiments, the controller 28 may be configured to make the physical devices 32 of the physical system 30 so-called “intelligent” and capable of executing compute-intensive processes such as machine learning, computer vision, and/or remote control. The secondary digital twin 24 is preferably configured to provide real-time adjustments and operational controls of the one or more physical devices 32 in the physical system 30. Such adjustments and operational controls may be based on strategic insights provided by the primary digital twin 22.

In some embodiments, the system 20 can elevate various infrastructure to Industry 4.0 standards. For example, each physical device 32 of the physical system 30 can act as an internet of things (IoT) sensor (e.g., sensor(s) 34) or actuator (e.g., control device(s) 36), recording data and keeping track of everything connected. This data collection and management capability allows for enhanced monitoring, control, and optimization of all connected systems. This approach to using the system 20 may also be used by OEMs for building new industrial machines that require a PLC, offering a transformative leap towards Industry 4.0 standards. The system 20 can also be effectively applied to newly-built or existing industrial robotics. This capability enables robots that are already deployed in factories to be seamlessly integrated into Industry 4.0 standards. By leveraging the system 20, robots are able to gain dynamic control capabilities, full customizability beyond pre-programmed operations, and the ability to be repurposed on the fly, regardless of their manufacturer.

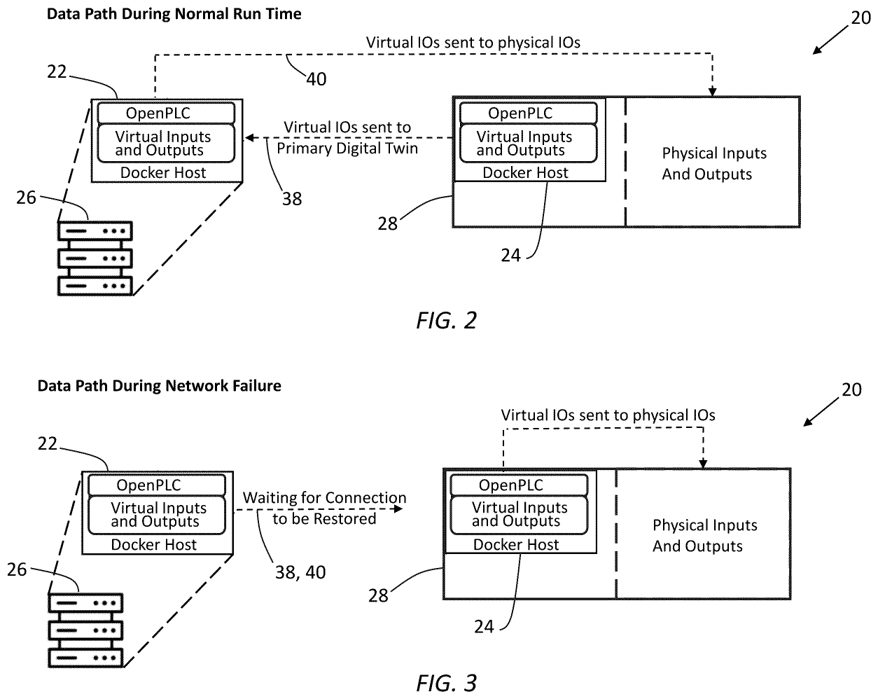

The system 20 is configured to improve operational continuity of industrial systems in case operational failures of either the primary digital twin 22 or the secondary digital twin 24 or of network connections between the digital twins 22 and 24 and/or the digital twins and the physical devices 32. To accomplish this, the system 20 is configured to allow the local twin (secondary digital twin 24) to independently sustain operations of the respective physical devices 32 during central server failures or network disruptions, minimizing downtime and maintaining productivity. For example, FIG. 2 illustrates the flow of data during a normal run time when both the primary digital twin 22 and the secondary digital twin 24 are fully operational and the data network connections 38 and 40 between them are fully operational and functioning. In this scenario, the secondary digital twin 24 communicates virtual IOs (input/output signals) to the primary digital twin 22 over a network connection 38. These virtual IOs may correspond to physical IO signals generated by the various sensors 34 and/or control devices 36 in the physical system 30. In addition, the primary digital twin 22 communicates virtual IOs to physical IOs on the controllers 28, which may communicate corresponding physical IO signals to the appropriate control devices 36 and/or sensors 34 in the physical system 30 as appropriate.

FIG. 3 illustrates the flow of data during a network failure that interrupts data communication between the primary digital twin 22 and the secondary digital twin 24. In this scenario, the network disruption prevents data flow along the data network connections 38/40. While the system 20 is waiting for the data network connections 38/40 to be restored, the system 20 automatically changes the data flow so that the secondary digital twin 24 takes over controlling the physical system 30 during the network interruption. In this scenario, the secondary digital twin 24 communicates virtual IOs to the physical IOs on the controller 28, which may communicate the IO signals generated by appropriate sensors 34 and/or control devices 36 in the physical system 30. When the network connection 38/40 is restored, the system 20 automatically reverts to the normal run time data flow path illustrated in FIG. 2. In addition, the dual digital twin system 20 safeguards against system failures of either of the computer processing system 26 or the controller 28 by enabling a secondary control system (e.g., the secondary digital twin 24) embedded within the physical controller 28 to seamlessly and automatically take over controlling the physical system 30 if the primary digital twin 22 fails or otherwise malfunctions. Likewise, if the physical controller 28 fails (malfunctions), the primary digital twin 22 automatically takes control of controlling the physical system 30. When the failed computer processing system 26 or controller 28 is again operational, the system 20 automatically reverts to the default normal run time operational configuration. In this manner, seamless failover between the primary digital twin 22 and the secondary digital twin 24 can be realized. To attain this operation, the primary and secondary digital twins 22 and 24 execute a software product comprising one or more non-transitory computer-readable media that store instructions which, when executed by one or more processors, cause the processors to implement the seamless failover between the primary digital twin 22 and the secondary digital twin 24.

In some configurations, both digital twins 22 and 24 may be configured to strategically use data, for example, from the sensors 34 and/or other sources, to provide on-board validation that can enhance decision-making for various aspects of the physical system 30.

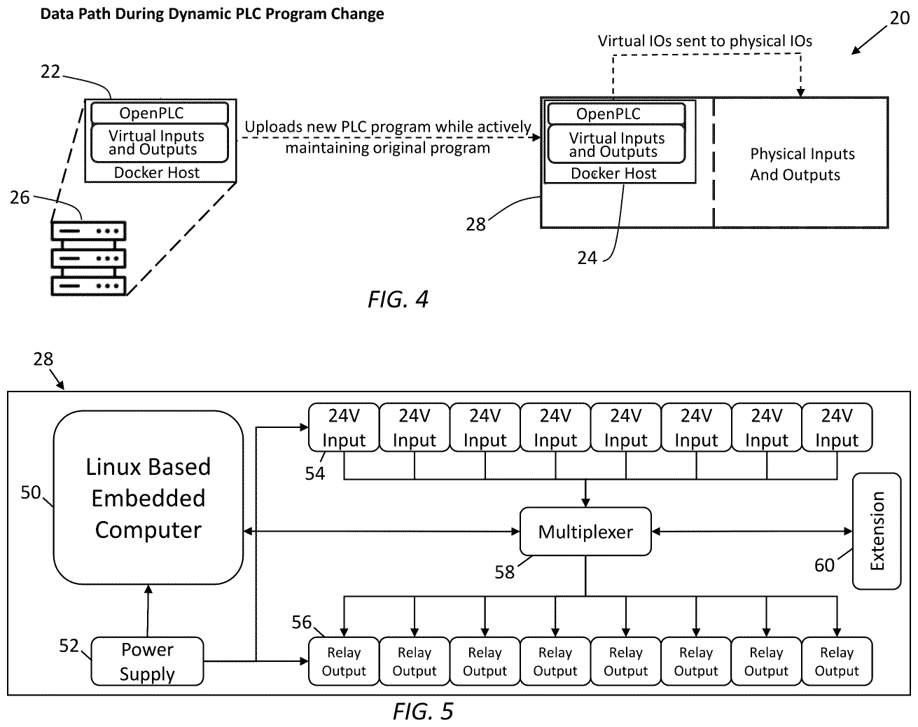

The system 20 can also facilitate real-time adaptability and mass customization of industrial systems. For example, the system 20 in some embodiments can be used to enable production lines to dynamically adjust operations to meet varying demands without needing to manually reprogram the various controllers (e.g., PLCs) that are used to control the various machines on the production line. FIG. 4 illustrates a nonlimiting example of a data path implemented by the system 20 during a dynamic programming change to control programs running on the controller 28. In this scenario, the primary digital twin 22 uploads a new control software program (e.g., a PLC program) along the network connection 38 while actively maintaining the original control software program while the software on the controller 28 is updating. During this software update, the secondary digital twin 24 continues to send IOs to the physical IOs to provide uninterrupted control of the physical devices 32. This allows the system 30 to continue receiving control signals from the controller 28 while the software program(s) on the controller 28 are updated without realizing any downtime. Once the control software programming has been fully updated, the system 20 can revert to its normal run time processing. Thus, the system 20 can provide for real-time, dynamic adjustments to control software programming, enabling high levels of mass customization and allowing manufacturers to quickly respond to changing production demands. This ability for dynamic adjustment of the process controls may be particularly valuable in industries that need flexible manufacturing processes.

In some embodiments, the system 20 has a modular, Docker-based, backward-compatible deployment that can be easily integrated with both legacy and modern process control structures infrastructures. In this way, the system 20 can seamlessly integrate with existing legacy systems, which can simplify technology upgrades, reduce costs, reduce the need for costly overhauls, and reduce implementation disruptions. This integration will allow new technologies to be leveraged while preserving investments in current systems. In some embodiments, for example, the secondary controller 28 can interface seamlessly with existing PLC setups and hardware protocols such as MODBUS or EtherCAT. This capability enables the conversion of existing infrastructure to utilize the benefits of the dual digital twin system 20 without requiring extensive hardware overhauls.

The system 20 in some embodiments may optimize resource use and promote sustainability by dynamically adjusting resource consumption based on real-time production needs, thereby reducing waste and enhancing cost-efficiency. Finally, the system 20 supports centralized control and remote management capabilities of equipment, allowing for the remote updating and management of control software programs. This may be particularly beneficial for large or geographically dispersed operations.

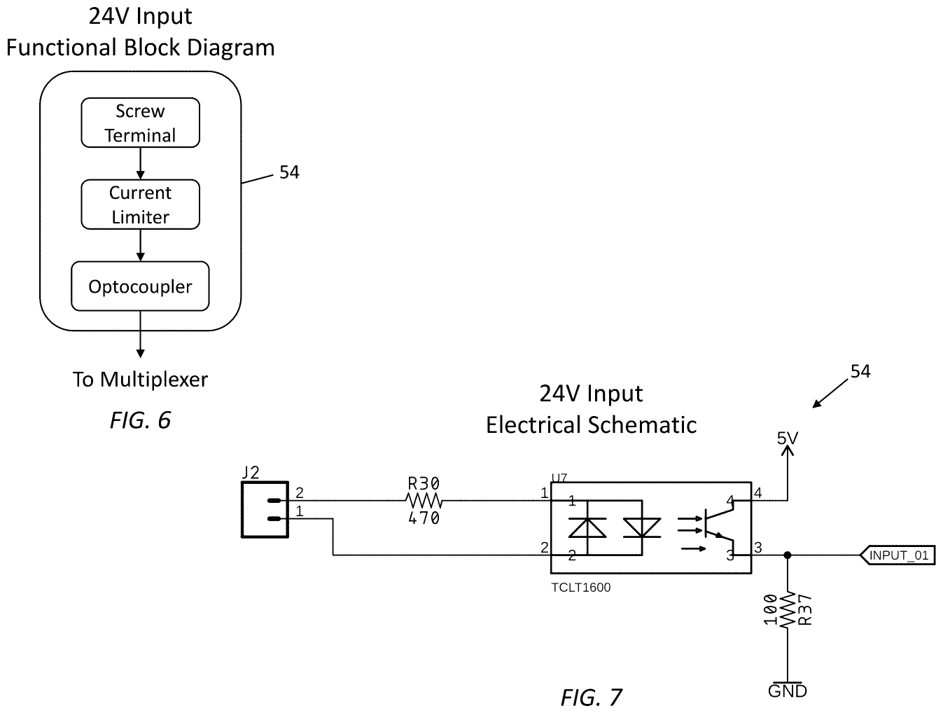

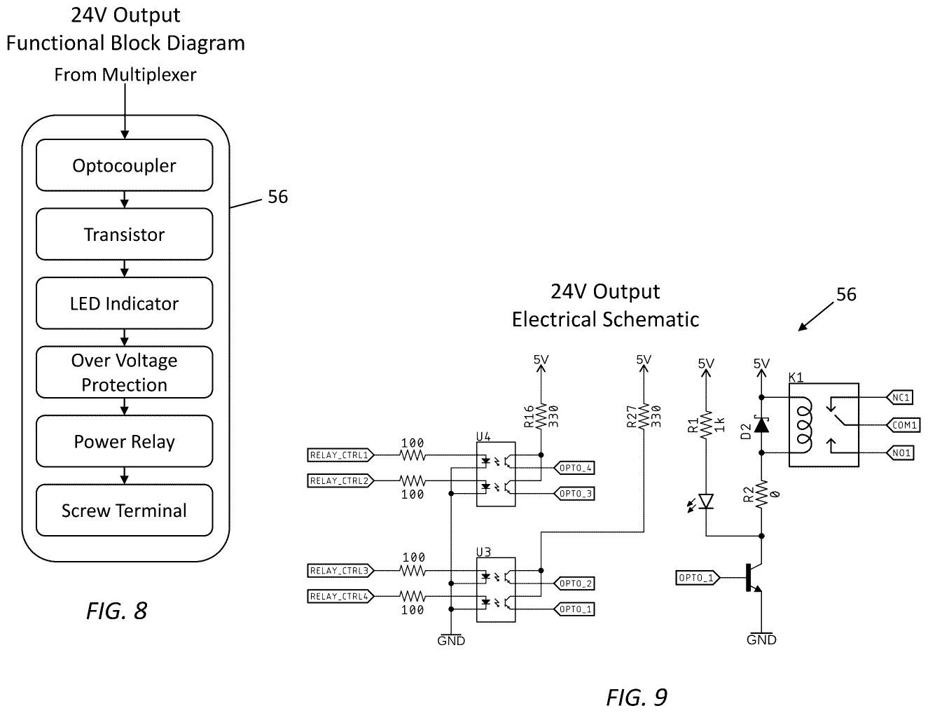

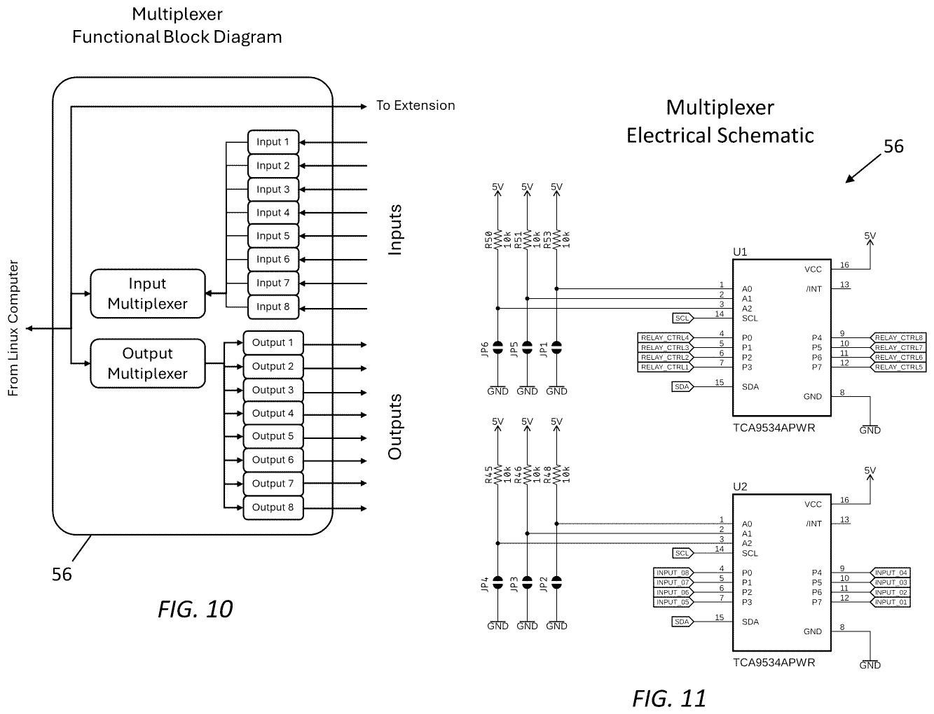

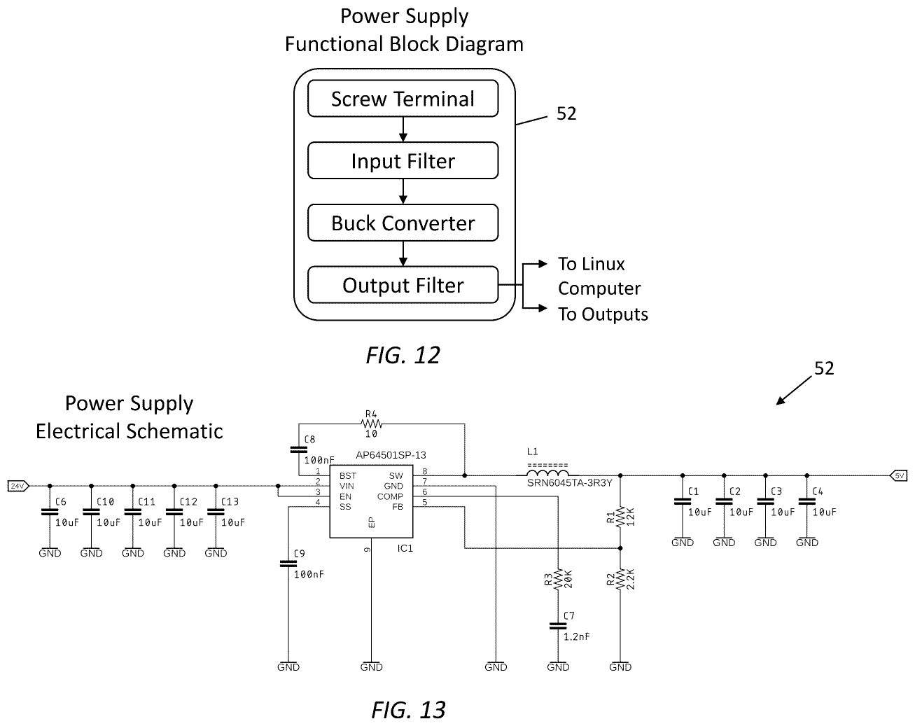

FIGS. 5 to 13 illustrate a nonlimiting configuration of the controller 28. FIG. 5 is a block diagram of the controller 28, including a Linux-based embedded computer processor 50, a power supply module 52, one or more 24V input modules 54, one or more relay output modules 56, a multiplexer 58, and an extension 60. The multiplexer 58 receives input signals from the input modules 54 and delivers output signals to the output modules 56. The computer processor 50 is in data communication with the multiplexer 58, and the power supply module 52 is operatively coupled to provide power to each of the computer processor 50, the input modules 54, and the output modules 56. The computer processor 50 is embedded with programming that, when executed, generates the secondary digital twin 24 of an associated physical device 32, and also embedded with programming that, when executed, communicates virtual IO with the primary digital twin 22 of the associated physical device 32 on a second processor. FIGS. 6 and 7 illustrate one of the 24V inputs 54, including a screw terminal, a current limiter, and an optocoupler that connects to the multiplexer 58. FIGS. 8 and 9 illustrate one of the 24V outputs 56, including an optocoupler, a transistor, an LED indicator, an over voltage protection, a power relay, and a screw terminal. FIGS. 10 and 11 illustrate the multiplexer 58, including input and output connected to the Linux-based embedded computer 50, and physical inputs and physical outputs connecting with various physical devices 32 of the physical system 30. FIGS. 12 and 13 illustrate the power supply module 52, including a screw terminal connected to an input filter connected to a buck converter connected to an output filter, which connects to the Linux-based embedded computer 50 as well as the relay outputs 56 and 24V inputs 54.

Next, a few examples of possible industrial applications for implanting the dual digital twin system 20 are described. It is understood that the system 20 may be readily adapted for any number of other types of applications, and the examples provided herein are not intended as limiting examples.

The dual digital twin system 20 may be implemented in a pharmaceutical manufacturing application. The pharmaceutical or manufacturing company can use the system 20 to manage a production line for medications. The primary digital twin 22 is hosted on the computer processing system 26 and continuously collects and analyzes data across the production line. The primary digital twin 22 is configured to simulate processes and predict outcomes of the production line, such as potential bottlenecks or equipment failures. The primary digital twin 22 is also configured to manage compliance reporting by ensuring all production standards are met. The secondary digital twin 24 is embedded directly within the controller 28 on the production line. The secondary digital twin 24 directly controls machinery, adjusting parameters like temperature and mixing speeds in real-time to ensure optimal production quality and efficiency. The secondary digital twin 24 sends real-time operational data, such as production speeds, machine temperatures, and quality control metrics, to the primary digital twin 22. The primary digital twin 22 analyzes this data to optimize processes and predict potential disruptions. The secondary digital twin 24 receives strategic adjustments and updates from the primary digital twin 22 based on the analysis performed using the primary digital twin, thereby allowing the secondary digital twin 24 to fine-tune operations for better adherence to quality standards and efficiency. This dynamic adjustment helps the primary digital twin 22 to refine its models and strategies, improving its predictive accuracy over time while freeing up computing resources on the secondary digital twin to focus on the primary control of the production line equipment.

The dual digital twin system 20 may be implemented in an energy and resource management application. For example, a solar power plant can use the dual digital twin system 20 to optimize power output and manage distribution. In this example, the primary digital twin 22 models the entire energy system, including production, storage, and distribution, to optimize efficiency and manage loads dynamically based on consumption patterns and weather forecasts. The secondary digital twin 24 interfaces directly with the control systems at the plant, executing adjustments in real-time to maintain energy production efficiency, such as changing the angle of solar panels throughout the day to maximize energy capture. Operational data such as energy output, storage levels, and grid demand from the secondary digital twin 24 are sent to the primary digital twin 22, which uses this data to model energy flows and optimize distribution strategies. The primary digital twin 22 can then provide the secondary digital twin 24 with predictive data on anticipated energy demand and production conditions, enabling the secondary digital twin 24 to adjust control strategies in real-time, thus enhancing operational efficiency and reliability. Feedback from the secondary digital twin 24 can be used by the primary digital twin 22 to improve its energy management models. Again, using the primary digital twin 22 to provide higher-level data analysis and modelling can free up computing resources on the secondary digital twin 24 to focus on the primary control of the production line equipment.

The dual digital twin system 20 may be implemented in a logistics and warehousing application. For example, a distribution center may use the dual digital twin system 20 for inventory management and logistics. The primary digital twin 22 analyzes overall warehouse operations, simulating scenarios like optimal storage configurations and efficient routing paths for picking robots. The secondary digital twin 24 manages the controller 28 controlling automated storage and retrieval systems, executing adjustments to storage racks and robot paths based on real-time inventory changes and shipment priorities. The secondary digital twin 24 sends data on inventory levels, robot efficiency, and process bottlenecks to the primary digital twin 22, which then analyzes this information to optimize warehouse layout and logistics. The primary digital twin 22 sends optimized picking paths and storage solutions back to the secondary digital twin 24, which adjusts the warehouse operations accordingly. This interaction helps the primary digital twin 22 to better understand real-world logistical challenges, refining its simulation models, while freeing up computing resources on the controller 28 to attend to control of the warehouse equipment.

Investigations have been conducted that demonstrate that the system 20 can also be effectively applied to industrial robotics. This advancement enables legacy robots-those already deployed in factories-to be seamlessly integrated into Industry 4.0 standards. The system 20 enables robots to gain dynamic control capabilities, full customizability beyond pre-programmed operations, and the ability to be repurposed on the fly, regardless of their manufacturer.

As reported in K. Alremeithi, P. Giri, and W. Sealy, “Collaborative Intelligent Industrial Robots (CIIR) Framework,” 2023 International Conference on Electrical, Communication and Computer Engineering (ICECCE), Dubai, United Arab Emirates, December 2023, pp. 1-6, doi: 10.1109/ICECCE61019.2023.10442250, testing was conducted on three legacy robots (with minimal network connectivity) acquired from two different vendors. The system 20 successfully facilitated communication between the robots and a central server. Each vendor's robot was equipped with a custom software-based translator that converted commands of the system 20 into the vendor-specific syntax, ensuring proper execution of required tasks.

Additionally, T. C. Washington and W. Sealy, “Programming by Demonstration using Mixed Reality and Simulated Kinematics,” 2024 IEEE World AI IoT Congress (AIIoT), Seattle, WA, USA, 2024, pp. 387-392, doi: 10.1109/AIIoT61789.2024.10579016, discloses an investigation that was conducted to evaluate the capability of the system 20 with an industrial robot. A real-time engine served as a digital twin of the physical robot, accurately replicating the robot's actions. Using the system 20, command development and deployment was carried out in a manner similar to how the system 20 is described above. A framework was developed that enabled users to program and control industrial robots using a Mixed Reality (MR) headset. Within the system 20, a user selected a position in the virtual environment of the robots, after which the real-time digital twin validated the position by simulating the movement and making necessary corrections. Once validated, the position data was transmitted to the robot for execution.

These results of the investigations evidenced the versatility of the system 20 as extending beyond PLCs to industrial robotics, digital twins, and mixed-reality-driven programming.

Of course, the dual digital twin system 20 is not limited to use in industrial applications, and as such may also be implemented in commercial applications. Thus, the dual digital twin system 20 may be implemented in a building and infrastructure management application. For example, a commercial high-rise building may integrate the system 20 for its building management system. The primary digital twin 22 can be utilized to model energy consumption, occupant behavior, and environmental conditions to optimize HVAC and lighting settings for energy savings and comfort. The secondary digital twin 24 can be utilized to directly control HVAC and lighting systems and adjust settings in real-time based on inputs from the primary digital twin 22 and sensors throughout the building. Sensor data from the building, such as occupancy rates, energy usage, and environmental conditions, flow from the secondary digital twin 24 to the primary digital twin 22 for analysis and optimization of building operations. The primary digital twin 22 provides optimized control strategies for HVAC and lighting systems, which the secondary digital twin 24 implements. This cyclical data flow allows the primary digital twin 22 to refine its predictions and operational efficiency, while the secondary digital twin 24 implements the most current strategies for energy conservation and occupant comfort.

The dual digital twin system 20 may be implemented in retail and hospitality applications. For example, a hotel chain may use the system 20 for providing personalized guest management. The primary digital twin 22 can be utilized to analyze guest preferences and behaviors to optimize room assignments, temperature settings, and even entertainment options. The secondary digital twin 24 can be utilized to interface with the hotel's operational systems, directly adjusting room settings prior to and during a guest's stay to enhance comfort and satisfaction. Guest preferences, room usage data, and operational efficiencies from the secondary digital twin 24 are sent to the primary digital twin 22, which uses this data to enhance guest experience management and service optimization. The primary digital twin 22 provides personalized service recommendations and operational adjustments back to the secondary digital twin 24, enabling tailored guest experiences and efficient hotel management. The data from the secondary digital twin 24 allows the primary digital twin 22 to continually improve its guest behavior models and service strategies.

The dual digital twin system 20 may also be implemented in residential applications. In this example, the dual digital twin system 20 may be implemented in a smart home automation application. For example, a smart home may be equipped with the system 20 for integrated device management. The primary digital twin 22 collects data on household patterns and environmental conditions to model energy use and predict optimal settings for devices. The secondary digital twin 24 directly controls home devices such as thermostats, lighting, and security systems, adjusting them according to the predictions and real-time data, enhancing efficiency and comfort. The secondary digital twin 24 sends detailed usage data on energy consumption, device operation, and environmental changes to the primary digital twin 22, which models energy-saving strategies and optimal device settings. The primary digital twin 22 sends these optimized settings back to the secondary digital twin 24 for implementation, ensuring the home operates at peak efficiency. The feedback loop helps the primary digital twin 22 to refine its models for better future predictions and tailored adjustments.

The dual digital twin system 20 may be implemented in security and personalized services applications. For example, the system 20 may be incorporated as part of a residential security system. The primary digital twin 22 models potential security threats based on historical data and neighborhood trends, predicting likely security breaches. The secondary digital twin 24 controls, cameras, alarms, and locks, dynamically adjusting security measures based on the threat level identified by the primary digital twin 22. Surveillance data and system status updates from the secondary digital twin 24 are sent to the primary digital twin 22, which uses the information to enhance security protocols and predict potential threats. The primary digital twin 22 updates the secondary digital twin 24 with refined threat levels and response strategies, allowing for adaptive security measures that are preemptively adjusted based on predicted risks. This exchange enables the primary digital twin 22 to continuously learn and improve its threat modeling capabilities.

The dual digital twin system 20 may be implemented in diagnostics tool applications. The secondary digital twin 22 may act as an intelligent diagnostic tool, enhancing the plant's ability to maintain and troubleshoot its automation systems effectively. For example, a manufacturing plant may use the secondary digital twin 24 as a diagnostic tool for its existing controller network. The secondary digital twin 24 connects to the controller 28 and scans all connected plant devices and sensors, mapping out the entire network. The secondary digital twin 24 can visualize connections and provide a detailed layout of the plant system, making it easier to troubleshoot and trace wiring issues. The secondary digital twin 24 sends the scanned data and network map to the primary digital twin 22, which analyzes it to identify potential issues or inefficiencies in the controller network. The primary digital twin 22 provides insights and recommended actions to the secondary digital twin 24, which then guides maintenance personnel through troubleshooting steps. This interaction streamlines the diagnostic process, reduces downtime, and enhances the overall reliability of the automation system.

In view of the above, it can be seen that the system 20 provides a robust solution that may enhance efficiency, flexibility, and/or sustainability in industrial environments. The system 20 in some embodiments can effectively address several critical challenges in industrial control systems, such as system resiliency, adaptability, and integration with existing technologies.

Compared to conventional solutions, the dual digital twin system 20 and associated methods of the present invention may, in preferred embodiments, provide a more resilient and adaptable system, as well as the ability to make practical, on-the-ground control adjustments and/or provide fail-safe operational continuity.

As previously noted above, though the foregoing detailed description describes certain aspects of one or more particular embodiments of the invention, alternatives could be adopted by one skilled in the art. For example, the dual digital twin system 20 and its components could differ in appearance and construction from the embodiments described herein and shown in the drawings, functions of certain components of the dual digital twin system 20 could be performed by components of different construction but capable of a similar (though not necessarily equivalent) function, and various materials could be used in the fabrication of the dual digital twin system 20 and/or its components. As such, and again as was previously noted, it should be understood that the invention is not necessarily limited to any particular embodiment described herein or illustrated in the drawings.

1. A dual digital twin system for analyzing and/or controlling an associated physical device, the dual digital twin system comprising:
a primary digital twin hosted on a computer processing unit configured for robust data handling and system reliability; and
a secondary digital twin embedded within a computerized control device configured for direct control over operations of the associated physical device.

2. The dual digital twin system of claim 1, wherein the computerized control device comprises a programmable logic controller (PLC).

3. The dual digital twin system of claim 1, further comprising a Docker-based environment that allows multiple control programs to be executed on demand.

4. The dual digital twin system of claim 1, wherein the secondary digital twin is configured to take control of the associated physical device if the primary digital twin fails, and wherein the primary digital twin is configured to take control of the associated physical device if the secondary digital twin fails, whereby the dual digital twin system can provide continuous operation when either one of the primary digital twin or the secondary digital twin stops operating.

5. The dual digital twin system of claim 4, wherein the secondary digital twin is configured to take control automatically and seamlessly if the primary digital twin fails, and wherein the primary digital twin is configured to take control automatically and seamlessly if the secondary digital twin fails.

6. The dual digital twin system of claim 1, wherein:
the primary digital twin uploads new control programming to the secondary digital twin to supersede existing control programming on the computerized control device; and
while the primary digital twin uploads the new control programming, the primary digital twin actively maintains the existing control programming and the secondary digital twin is configured to control the associated physical device using the existing control programming.

7. The dual digital twin system of claim 1, wherein the associated physical device is an industrial machine or an industrial robot.

8. A computer-implemented method of using the dual digital twin system of claim 5, the method comprising:
dynamically adjusting operations of the computerized control device in real time based on sensor data and/or production requirements to meet varying production demands and/or material specifications.

9. The computer-implemented method of claim 8, wherein the step of dynamically adjusting is performed without manual reprogramming of the computerized control device.

10. The computer-implemented method of claim 8, wherein the step of dynamically adjusting comprises remotely updating and managing a program hosted on the computerized control device.

11. The computer-implemented method of claim 8, comprising using data and on-board validation from both the primary and secondary digital twins to enhance decision-making.

12. The computer-implemented method of claim 8, comprising reprogramming in real-time a plurality of controllers to operate in different manners from each other to produce a corresponding plurality of different products without stopping or reconfiguring production lines associated with the plurality of controllers.

13. The computer-implemented method of claim 8, wherein the associated physical device is an industrial machine or an industrial robot.

14. A computer-implemented method of using the dual digital twin system of claim 3, the method comprising:
automatically switching control of the associated physical device from the primary digital twin to the secondary digital twin when the primary digital twin malfunctions; and
automatically switching control of the associated physical device from the second digital twin to the primary digital twin when the secondary digital twin malfunctions;
whereby seamless failover between the primary digital twin and the secondary digital twin is realized.

15. The computer-implemented method of claim 14, further comprising automatically switching control of the associated physical device from the primary digital twin to the secondary digital twin when data communication between the primary digital twin and the secondary digital twin is interrupted.

16. The computer-implemented method of claim 14, wherein the associated physical device is an industrial machine or an industrial robot.

17. A software product comprising one or more non-transitory computer-readable media comprising instructions which, when executed by one or more processors, cause the one or more processors to implement the computer-implemented method of claim 14.

18. A programmable logic controller (PLC) for controlling an associated physical device, the PLC comprising:
a multiplexer that receives input signals from one or more input modules and delivers output signals to one or more output modules;
a computer processor in data communication with the multiplexer; and
a power supply module operatively coupled to provide power to each of the computer processor, the input modules, and the output modules;
wherein the computer processor is embedded with programming that, when executed, generates a secondary digital twin of the associated physical device; and
wherein the computer processor is embedded with programming that, when executed, communicates virtual input and/or output with a primary digital twin of the associated physical device on a second processor.

19. The PLC of claim 18, wherein one or more of the input modules is configured to receive operational data from the associated physical device, and one or more of the output modules is configured to deliver control signals to the associated physical device.

20. The PLC of claim 18, wherein one or more of input modules is configured to receive virtual input/output signals from the primary digital twin, and one or more of the output modules is configured to deliver virtual input/output signals to the primary digital twin.
